(19) United States
(12) Patent Application Publication
(10) Pub. No.: US 2002/0156708 A1
(43) Pub. Date: Oct. 24, 2002

(54) PERSONALIZED INTERNET SERVER

(76) Inventor: YZHAK RONEN, WEST WINDSOR, NJ (US)

Correspondence Address: MR. SAMUEL H. DWORETSKY, AT& T CORP, BOX 4110, MIDDLETOWN, NJ, 07748, US

(21) Appl. No.: 09/222,804

(22) Filed: Dec. 30, 1998

(51) Int. Cl. G06F 17/60

(52) U.S. Cl. 705/35

(57) ABSTRACT

A subscriber at a client station connects to an Personal Internet Service Provider (PISP) station and then chooses a site from which to download data. An Internet Protocol addressing element at the PISP station receives the client station request and retrieves identifying information from a database on a storage device at the PISP station corresponding to the requesting client station. A personal server element at the PISP station uses the client station request to formulate a TCP/IP request to an Internet site corresponding to a URL specified at the client station. The personal server element thus retrieves the requested data and passes it to a caching element at the PISP station. The caching element stores the data temporarily at the PISP station allowing concurrent processes other than the personal server element to control return of the data to client station. The personal server element can also maintain identifying information (e.g. usernames, passwords, etc.) to provide other convenient services to subscribers, including security, automatic data retrieval, and location independent user environment.

### FIELD OF THE INVENTION

This invention relates to a method and apparatus for providing each Personalized Internet Server Provider (PISP) subscriber with a permanent presence on the Internet that enables new services and enhanced Internet access services.

### BACKGROUND OF THE INVENTION

In recent years, the Internet has become more popular, allowing users to access information in ways never before possible. At the touch of a button, any time or day, the Internet subscriber has at his disposal a vast, ever growing information database.

Despite these advances, Internet access has its drawbacks. One drawback of primary concern to Internet developers as well as Internet Access Providers (IAP) is the limited bandwidth (transmission capacity) of Internet communications lines. Many applications involve the download of relatively large amounts of data from an Internet server site. Thus, Internet access is often relatively slow. This problem is particularly acute when, as is often the case, Plain Old Telephone Service (POTS) lines connect a subscriber to an IAP at a maximum 28.8, 33.6, or 56.6 kbps transmission rate.

Another drawback of current Internet access is that even for those users with a permanent connection to the Internet logging on for extended periods of time may be inconvenient. Although a subscriber may have numerous interests, browsing the Internet or visiting numerous web sites is often too time consuming. Thus, many may be unable to fit the required Internet access session involving visits to many websites into a busy schedule.

In addition, some individuals who might benefit and enjoy Internet access may nevertheless be unable to afford it. Although IAP's typically provide unlimited access for a modest fee, the subscriber must first purchase a computer system costing significantly more. At the same time, much of the processing capabilities of a subscriber's computer system appear redundant given the subscriber's access to the IAP as well as other service providers on the Internet that have more powerful computing capabilities.

### SUMMARY OF THE INVENTION

Thus, it would be advantageous if each IAP subscriber were given a permanent Internet presence using the considerable computing power of the PISP to reduce the computing power necessary at the subscriber's location and enhance the subscriber's Internet usage through new services. The present invention addresses this need.

Specifically, the present invention consists of one or more PISP stations, including a personal server element, storing identifying information unique to each subscriber. The personal server element effects many of the client functions typically handled by a browser at the client computer, such as download requests to Internet server sites, maintaining personal information about the subscriber to be automatically supplied to websites as necessary, and improved security to protect the subscriber from harmful files or website content before that material ever reaches the subscriber. The subscriber may access this PISP station merely by accessing it through the Internet, and the processing requirements on the subscriber end are greatly diminished. The present invention also maintains all of the subscriber's identifier information in one place which the subscriber may use from any location at which the subscriber can get access to the Internet.

The advantages and benefits of the present invention will become apparent upon review of the detailed description provided below.

### BRIEF DESCRIPTION OF THE INVENTION

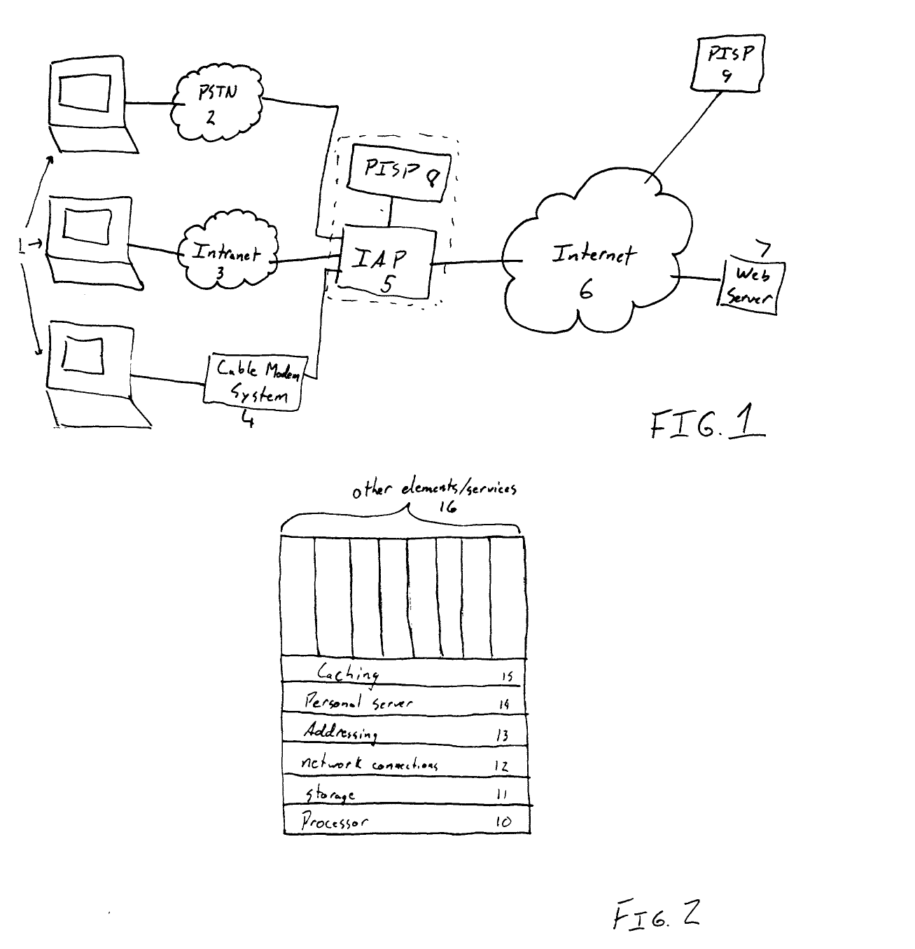

FIG. 1 illustrates a system in which an embodiment of the present invention may be deployed.

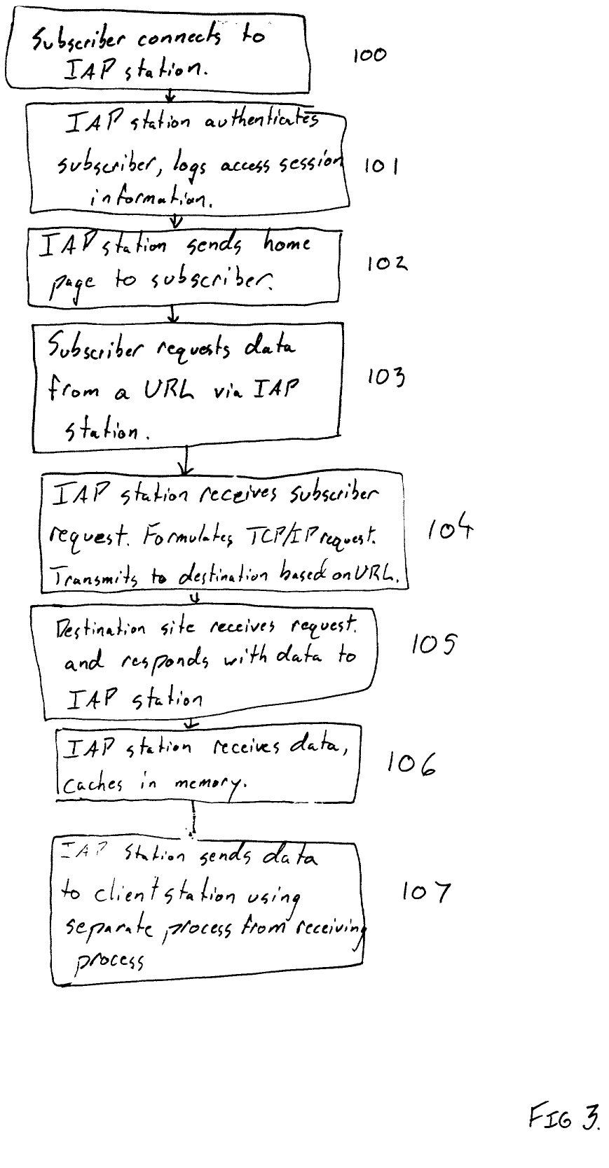

FIG. 2 shows a more detailed symbolic depiction of one possible embodiment of an PISP station of the present invention.

FIG. 3 is a chart depicting a process flow allowing Internet access in accordance with an embodiment of the present invention.

### DETAILED DESCRIPTION

FIG. 1 shows a system in which one embodiment of the present invention may be deployed. One or more client stations 1 can be coupled via the Public Switched Telephone Network (PSTN) 2, a corporate intranet 3, or a cable modem system 4, to an Internet Access Provider (TAP) 5. The TAP 5, in turn, is connected to the Internet 6 (i.e., the well known globally interconnected network of host servers, including World Wide Web servers 7). The client station 1 can connect to a Personal Internet Server Provider (PISP) 9 via the IAP 5 and Internet 6. This connection is established following the authentication and authorization of the subscriber by the TAP 5, and authentication and authorization of the subscriber by PISP 9. Alternatively, this embodiment could be simplified if the service is offered by the IAP 5 where the PISP is directly connected to the IAP 5 as shown by PISP 8 in FIG. 1. The following description focuses on when the IAP 5 and PISP 8 are integrated and in references to the PISP 8, it is referring to services offered by the PISP 8 in conjunction with IAP 5.

The client station 1 shown in FIG. 1 is a conventional computer system used by PISP subscribers to access the Internet 6. It may include a computer processing device, storage device (e.g., a hard drive), display device, user input device (e.g., keyboard) and browser element.

The browser element can be implemented on the client station 1 as conventional, commercially available software (i.e., a program, process) whose instructions are executed by the computer processing device. The browser element, among other things, includes client processes which allow the client station 1 to issue data requests to Internet sites using variations of the Internet Protocol (IP), including Hypertext Transfer Protocol (HTTP), the protocol of the World Wide Web. Adequate commercial examples of the browser element include Microsoft, Inc.'s Internet Explorer (TM) line or Netscape, Inc.'s Netscape Communicator (TM) line. The browser element could also be implemented using other commonly known computer networking methods and protocols, or via proprietary networking technology that may be designed specifically for the present invention and implemented by special software on the client station 1 and the PISP station 8.

According to conventional practice, a PISP subscriber at client station 1 dials a modem, (e.g. a conventional POTS modem, or an ISDN modem), to connect to the IAP 5, which typically includes a rack of modems which accept multiple incoming calls simultaneously. The call is completed over the PSTN 2 by a switching station at the central office of a telephone service provider. Once the call to the IAP 5 is completed, the client station 1 is assigned a temporary Internet Protocol (“IP”) address and is accordingly connected to the Internet 6. As previously mentioned, if the IAP and PISP are not integrated the subscriber must also connect to and be authenticated by the PISP station. The browser element at the client station 1 can then issue data and download requests to web servers 7 using the PISP station 8 as a conduit. As previously mentioned the subscriber could also access the PISP via a corporate intranet 3 or a cable modem system 4 that generally have permanently assigned IP addresses.

However, as noted earlier, such Internet access practices may be improved. For instance, in typical practice, once the client station 1 is connected to the Internet, the IAP station 5 serves as a mere conduit for the passage of data to and from the client station 1 and a desired Internet site (e.g., a web server 7). The IAP station 5 accomplishes this passage of data like any other Internet site—using Transmission Control Protocol/Internet Protocol (TCP/IP) software processing executed by a processing device (e.g., a Pentium chip). TCP/IP processing, the standard protocol allowing Internet communication, checks the contents of packets reaching the IAP station 5 and routes the packets in accordance with their respective IP addresses. In the case of packets destined for client stations 1, the data is routed using their respective IP addresses.

One drawback of this arrangement is that TCP/IP processing at the IAP station 5 may be subject to relatively high volume of traffic between client stations 1 and Internet sites. This is especially problematic as the IAP station 5 may be held hostage to the typically slow bandwidth capacity of POTS lines connecting the client station 1 to the IAP station 5. For example, TCP/IP processing might wait to pass along a client station 1 request while data from web server 7 is sent to other client stations 1 over POTS lines (typically at 28.8 kbps) or to client stations over ISDN lines or leased lines that may operate at a lower data rate than the IAP's connection to the rest of the Internet.

Thus, this process could be improved if, in accordance with the present invention, the processes typically handled by the browser element at the client station 1 are moved to the PISP station 8. In that case, once the PISP station 8 obtains data in response to an Internet site request, the data may be cached or temporarily stored. Then, a separate, concurrent process might forward the data to the client station 1, while the PISP station 8 processes other requests on behalf of client station 1 or other client stations.

Using this design, Internet client-server communication bypasses the lower bandwidth lines connecting the PISP station 8 and client station 1. As a result, IAP's may achieve greater efficiency in handling incoming client station 1 requests.

Moving functionality from the client station 1 to the PISP station 8 includes other benefits as well. For example, as Internet commerce is increasing in popularity, it is common for subscribers at client stations 1 to visit Internet sites with shopping pages. These pages typically display a menu of items and allow selection and purchase of the items. Conventionally, while completion of the purchase transaction is pending, a “shopping bag” software element at the client station 1 maintains a list of these items while a “cash and wallet” software element tabulates their cost. These “shopping bag” and “cash and wallet elements” are typically implemented as small files stored on the client station (e.g. browser “cookies”), or as small downloaded programs (e.g. Java or ActiveX applets).

Unfortunately, in the event of a malfunction at the client station 1, the data which the “shopping bag” and “cash and wallet” elements maintain may be lost. These processes also add to the computing requirements at the client station. In addition, most online shopping websites require several additional steps to authenticate a user and authorize a purchase transaction. These steps usually involve creating a secured connection between the purchaser and the shopping website. Instead of requiring that this interaction between the shopping web server 7 and the client 1 be conducted on the slower link through the PSTN 2, corporate intranet, etc, the present invention could accomplish the authentication and authorization on only the faster link through the Internet 6 between the PISP station 8 and the shopping web server 7. Therefore, significant benefits might be realized by moving these functions to the PISP station 8.

The present invention can also enable the subscriber to store various personal identification information on the PISP station 8 to be supplied to various websites automatically or whenever the subscriber directs the information to be supplied. If the PISP is enabled to supply this information automatically, it may intercept the website's request for the information and respond to it without ever forwarding the request on to the client station. In this way, the PISP can reduce the amount of traffic that is required to be transferred across the connection between the PISP and the client station, thus resulting in a greater number of connections between the PISP and the website than between the PISP and the client station. The personal information can include usernames and passwords for specific websites, credit card numbers for purchasing products, or other information customized by the subscriber for a particular website.

The present invention can also enable the subscriber to have a personal environment that can be accessed from any location that the subscriber is logged on from. This personal environment would include the personal identification information mentioned previously as well as other items such as an email address list, a list of favorite websites, information items to be kept continuously up-to-date, etc. For example, the subscriber could log onto the Internet from a different location, access the PISP station through the Internet, and then use all of the services provided by the PISP just as if the subscriber was logging in from their home or office.

The present invention could also provide features that would reduce the amount of time required for the subscriber to visit all the websites they desire to, by gathering certain pieces of information in advance that could be downloaded as soon as the subscriber logged in, thus reducing the amount of time that the subscriber would normally spend individually accessing different websites for this information. These items could include email, stock market reports, weather reports, sports scores, specific news items, etc. This feature could also be expanded to notify the subscriber by pager or similar method when a specific piece of information such as an email from a specific individual, a sports score, or a corporate prospectus was available on the PISP station 8.

In accordance with an embodiment of the present invention, FIG. 2 provides a more detailed symbolic depiction of the components of the PISP station 8 shown in FIG. 1. The PISP station includes a computer processing device 10, a storage device 11 and a plurality of network connections 12 to the Internet as well as the PSTN, corporate intranets, etc. The computer processing device 10 can be implemented with, for example, a single microprocessor chip (e.g., an Intel Pentium chip), printed circuit board, several boards or other device. The storage device 11 can be implemented with, for example, internal hard disks, Tape Cartridges, or CD ROMs. Conventionally, the storage device 11 stores data unique to each subscriber including, for example, billing or account information. In the presently described embodiment of the invention, the storage device 11 also stores the IP address corresponding to the client station 1. The IP address corresponding to the client station 1 could be permanently assigned or it may be a dynamic (i.e. temporary) address that only needs to be retained while there are outstanding communication requests between the client and the PISP station. However, the PISP station is always connected to the Internet via a permanent IP address, thus, a permanent, virtual Internet connection can be maintained for each subscriber.

The PISP station as shown in FIG. 2 also includes IP addressing element 13, personal server element 14 and caching element 15, each of which can be implemented as software whose instructions are executed by the computer processing device 10. The IP addressing element 13 initially receives a request for Internet data from client station 1. Upon receiving a request, the IP addressing element 13 searches a database of subscriber information located on the storage device 11 for a record matching the particular subscriber at the corresponding the client station 1 sending the request. The IP addressing element 13 then authenticates the subscriber's identity via a username and password or similar method and logs the client stations IP address for this access session in the database to ensure that the responses to the subscriber's requests are routed to the correct client station. For billing and other purposes, the PISP station 8 typically includes identifier (e.g., social security number, passwords, etc.) data in the database on the storage device 11 for each subscriber.

The personal server element 14 initiates TCP/IP requests for Internet data on behalf of a client station 1. More specifically, the personal server element 14 receives via the network connection 12 and the IP addressing element 13 the browser request of the subscriber at client station 1. The personal server element 14 then uses its own client processes to make a TCP/IP Internet request corresponding to the subscriber's request. The personal server element 14 will then receive Internet data from the web server 7, for example, to which the request was directed.

The caching element 15 receives Internet data which the personal server 14 element retrieves and stores the data temporarily on the storage device 11. This temporary storage allows other, concurrent processes to serve the data back to the client station 1 independent of the Internet requests that the personal server element 14 is handling. In this way, client-server processes operating on the Internet benefit from high transmission capacity lines while concurrent processes serve the data to the client station 1 at a slower rate (e.g., 28.8 kbps).

Other software elements 16 would exist on the PISP station to provide services other than Internet browsing. These elements would provide services as discussed above, including security, automatic data retrieval, password and credit card number storage, and email services. A service could also be provided that would notify the subscriber of the occurrence of particular events, including the arrival of e-mail or the availability of data that was requested for automatic retrieval. The notification could occur by pager, telephone, voice mail, e-mail, etc.

While the components of the presently described embodiment have been thus far described, a step by step description of the working interrelationship of those components is helpful in understanding the present invention. FIG. 3 is a chart depicting a process flow allowing Internet browsing in accordance with an embodiment of the present invention. This process flow is described from the perspective of an embodiment of the present invention wherein the PISP is integrated with the IAP.

Turning now to FIG. 3, in Step 100, a subscriber at a client station contacts the PISP station via a modem through the PSTN, a corporate intranet, a cable modem system, or any other well known network access method. In Step 101, The PISP station authenticates the subscriber based on a username and password or some other identification method, logs information (e.g., IP address) about the subscriber and client station into a database for use during the access session, and establishes a network connection between the client station and the PISP station. In Step 102, as in conventional practice, a “home page” is sent to the client station that is designed to aid in the subsequent access session.

In Step 103, the subscriber at client station chooses a site from which the subscriber would like to view data. As in conventional practice, the subscriber may interface with a browser or other interface by selecting a displayed “hyperlink” on the home page associated with a Universal Resource Locator (URL) or manually typing the URL in using the keyboard. Alternatively, the subscriber could use another commercially available software program designed for Internet access (e.g., an FTP program, a telnet program, etc.) or proprietary software designed specifically to work with the present invention.

In Step 104, the PISP station receives the client station request, including the URL of the site from which the subscriber wishes to view data. The PISP station formulates an appropriate TCP/IP request based on the client station request and transmits it over the Internet to the destination requested.

In Step 105, the destination site receives the PISP station request. Based on the data requested (e.g., a web page, a file download, etc.) and the nature of the destination (e.g., a web server, an FTP server, etc.), the destination site returns a response to the PISP station.

In Step 106, the PISP station receives the requested data and caches it in memory temporarily. Another process can then control the data return to the client station while the first process continues receiving the data from the destination site. In effect, this caching acts as a traditional buffer, holding data from a producer (i.e., the data being received from the destination site) for a consumer (i.e., the return to the client station) running at a different speed. Thus, data being received over the Internet is in no way impacted by the lower bandwidth applicable to the communications lines connecting the client station and the PISP station.

Finally, in Step 107, the PISP station returns the subscriber requested data to the client station. The data is typically in Hyper Text Markup Language (HTML), requiring a browser or other type of interface to convert the data into a viewable format but may be in another format appropriate to the software the subscriber is using or may be translated into a proprietary format, particular to the present invention, for transmission to the subscriber. Note that during the Internet access procedure depicted in FIG. 3, the subscriber perceives no difference from a standard Internet access session. This is true even though the PISP station, rather than the client station, is initiating data requests on behalf of the subscriber.

It should also be noted that to make use of most of the functionality of the present invention requires that all of the subscriber's data requests pass through the PISP so that the PISP can detect those data requests that are intended to activate its various services.

Furthermore, it is readily apparent that numerous other modifications and combinations of the above disclosure may be made for the benefit of PISP subscribers while remaining within the scope of the present invention. For example, the PISP station might also be configured to provide security by screening incoming Internet 4 packets. In that case, authentication and security processes typically found at the client station might also be moved to the PISP station. If the security requirements of a specific web site require that several communications are specified by the security protocol to authenticate the user and verify the security of the connection, all of these communications will occur via the high speed Internet connection rather than requiring the use of the slower client to IAP connection.

What is claimed is:

1. A Web access provider station allowing a Web access provider to provide a plurality of subscribers with continuous presence on the World Wide Web, the Web access provider station comprising:
a. at least one storage device, said at least one storage device storing,
i. identifying information for each one of the plurality of subscribers;
ii. one or more data files assigned to each of the plurality of subscribers;
b. at least one processing device coupled to said at least one storage device; and
c. a personal server element including instructions executed by said at least one processing device, said personal server element using said identifying information for each one of the plurality of subscribers to obtain Web data for said data files.

2. The Web access station of claim 1 wherein said personal server element further comprises:
a caching element, said caching element temporarily storing data retrieved from one or more World Wide Web sites in said data files for use by one or more of said plurality of subscribers.

3. The Web access station of claim 1 wherein the web access station further comprises:
a shopping bag software element including instructions executed by the at least one processing device, said shopping bag software element for maintaining information regarding a list of items ordered from one or more merchants over the World Wide Web.

4. The Web access station of claim 1 wherein the web access station further comprises:
a cash and wallet software element including instructions executed by the at least one processing device, said cash and wallet element for maintaining information regarding the cost of items ordered from one or more merchants over the World Wide Web.

5. The Web access station of claim 1 wherein the Web access station further comprises:
a packet filtering element including instructions executed by the at least one processing device, said packet filtering element preventing unwanted Internet data packets retrieved from Web servers on the Internet from being sent to said subscribers.

6. An Internet access station allowing an Internet Access provider to provide a plurality of subscribers with a continuous presence on the Internet, the Internet access station comprising:
a. at least one storage device, said at least one storage device storing,
i. identifying information for each one of the plurality of subscribers;
ii. one or more data files assigned to each of the plurality of subscribers;
b. at least one processing device coupled to said at least one storage device; and
c. a personal server element including instructions executed by said at least one processing device, said personal server element using said identifying information for each one of the plurality of subscribers to obtain data for said data files by initiating TCP/IP requests to TCP/IP servers on the Internet.

7. The Internet access station of claim 6 wherein said personal server software further comprises:
a caching element, said caching element temporarily storing data retrieved from one or more Internet sites in said data files for use by one or more of said plurality of subscribers.

8. The Internet access station of claim 6 wherein the Internet access station further comprises:
a shopping bag software element including instructions executed by the at least one processing device, said shopping bag software element for maintaining information regarding a list of items ordered from one or more merchants over the Internet.

9. The Internet access station of claim 6 wherein the Internet access station further comprises:
a cash and wallet software element including instructions executed by the at least one processing device, said cash and wallet element for maintaining information regarding the cost of items ordered from one or more merchants over the Internet.

10. The Internet access station of claim 6 wherein the Internet access station further comprises:
a packet filtering element including instructions executed by the at least one processing device, said packet filtering element preventing unwanted Internet data packets retrieved from servers on the Internet from being sent to said subscribers.

11. A computer based method for allowing a Personal Internet Server Provider to provide improved Internet access to subscribers; the computer based method comprising the steps of:
a. receiving from a client station a first request for data from an Internet site;
b. using identifying information assigned to the client station to formulate a second request to the Internet site based on said first request;
c. transmitting said second request to the Internet site;
d. receiving data from the Internet site in response to said second request; and
e. transmitting said data to said client station.

12. The computer based method of claim 1I further comprising the step of:
caching said data at the Internet Access Provider before transmitting to said client station.

13. The computer based method of claim 12 wherein the step of using identifying information assigned to the client station to formulate and transmit a second request to the Internet site is controlled by a first software element, and the step of caching the data at the Internet Access Provider is controlled by a second software element, the first software element differing from the second software element.

14. The computer based method of claim 13 wherein the first software element includes processes producing data at a first rate and the second software element includes processes consuming data at a second rate, the first rate differing from the second rate.

15. The computer based method of claim 14 wherein the number of requests transmitted and received from the Internet site is different than the number of requests received and transmitted from the client station.

16. The computer based method of claim 11 further comprising the step of checking said data for harmful or undesirable content before transmitting said data to said client station.

17. The computer based method of claim 12 further comprising the step of repeating steps b through e at regular time intervals.

18. The computer based method of claim 11 further comprising the step of:
providing information identifying the subscriber to said Internet site automatically when said Internet site requests such information.

19. The computer based method of claim 18 wherein said identifying information comprises credit card numbers.

20. The computer based method of claim 18 wherein said identifying information comprises a username and password.

21. The computer based method of claim 18 wherein said identifying information comprises the IP address of the client station.

22. The computer based method of claim 18 wherein said identifying information comprises a Social Security number.

23. A Personal Internet Server station providing a plurality of subscribers with a continuous presence on the Internet, the station comprising:
a. at least one storage device, said at least one storage device storing,
i. identifying information for each one of the plurality of subscribers;
ii. one or more data files assigned to each of the plurality of subscribers;
b. at least one processing device coupled to said at least one storage device; and
c. a personal server element including instructions executed by said at least one processing device, said personal server element using said identifying information for each one of the plurality of subscribers to obtain data for said data files by initiating TCP/IP requests to TCP/IP servers on the Internet.

24. The Personal Internet Server station of claim 23 wherein said subscribers access said station via an network connection.

25. The Personal Internet Server station of claim 24 wherein said network connection is an Internet connection.

26. The Personal Internet Server station of claim 24 wherein said network connection is a modem connection.

27. The Personal Internet Server station of claim 23 wherein said personal server software further comprises:
a caching element, said caching element temporarily storing data retrieved from one or more Internet sites in said data files for use by one or more of said plurality of subscribers.

28. The Personal Internet Server station of claim 27 further comprising:
a shopping bag software element including instructions executed by the at least one processing device, said shopping bag software element for maintaining information regarding a list of items ordered from one or more merchants over the Internet.

29. The Personal Internet Server station of claim 27 further comprising:
a cash and wallet software element including instructions executed by the at least one processing device, said cash and wallet element for maintaining information regarding the cost of items ordered from one or more merchants over the Internet.

30. The Personal Internet Server station of claim 27 further comprising:
a packet filtering element including instructions executed by the at least one processing device, said packet filtering element preventing unwanted Internet data packets retrieved from servers on the Internet from being sent to said subscribers.

31. The Personal Internet Server station of claim 23 further comprising:
a notification element including instructions executed by the at least one processing device, said notification element alerting said subscribers when a particular event occurs.

32. The Personal Internet Server station of claim 31 wherein said notification element alerts said subscribers via a pager.

33. The Personal Internet Server station of claim 31 wherein said notification element alerts said subscribers via e-mail.

34. The Personal Internet Server station of claim 31 wherein said notification element alerts said subscribers via voice mail.

35. The Personal Internet Server station of claim 31 wherein said particular event is the arrival of e-mail.

36. The Personal Internet Server station of claim 31 wherein said particular event is the availability of information previously requested by said subscribers.
